(19) United States
(12) Patent Application Publication
(10) Pub. No.: US 2025/0389248 A1
(43) Pub. Date: Dec. 25, 2025

(54) VERTICAL AXIS TURBINE

(71) Applicant: KOOTENAY KINETIC ENERGY TURBINE INC., Salt Spring Island (CA)

(72) Inventor: Andrew ROKEBY-THOMAS, Nelson, BC (CA)

(21) Appl. No.: 19/120,660

(22) PCT Filed: Oct. 13, 2023
(86) PCT No.: PCT/CA2023/051361

§ 371 Date: Apr. 11, 2025

Related U.S. Application Data
(60) Provisional application No. 63/415,920, filed on Oct. 13, 2022.
(60) Provisional application No. 63/433,215, filed on Dec. 16, 2022.

(51) Int. Cl. F03D 3/00; F03B 17/06; F03D 3/06

(52) U.S. Cl. CPC F03D 3/009; F03B 17/063; F03D 3/062; F05B 2240/213; F05B 2240/911; F05B 2250/25

(57) ABSTRACT

A vertical-axis turbine extending longitudinally along an axis of rotation is disclosed, wherein the turbine has first and second blades disposed around the axis of rotation, the first and second blades having proximal portions and distal portions located relatively close to and away from the axis of rotation respectively, and body portions located between the proximal portions and the distal portions. The turbine also has a rotor assembly coupled to an end of the first and second blades. The proximal portion of the first blade contacts the body portion of the second blade and the proximal portion of the second blade contacts the body portion of the first blade to form a closed volumetric region around the axis of rotation. The shape of the first and second blades may be defined by twisting a sheet of flexible material according to a frame comprising two or more pairs of battens.

### RELATED APPLICATIONS

This application claims priority from U.S. Patent Application No. 63/415,920 filed Oct. 13, 2022 entitled “VERTICAL AXIS TURBINE” and U.S. Patent Application No. 63/433,215 filed Dec. 16, 2022 entitled “VERTICAL AXIS TURBINE”. For the purposes of the United States, this application claims the benefit under 35 U.S.C. § 119 of U.S. Patent Application No. 63/415,920 filed Oct. 13, 2022 entitled “VERTICAL AXIS TURBINE” and U.S. Patent Application No. 63/433,215 filed Dec. 16, 2022 entitled “VERTICAL AXIS TURBINE”. United States Patent Application Nos. 63/415,920 and 63/433,215 are incorporated herein by reference in their entirety for all purposes.

### TECHNICAL FIELD

The present disclosure relates generally to turbine design. Particular embodiments relate to vertical-axis wind turbines (VAWTs) and vertical-axis hydro turbines (VAHTs), exemplary applications of which include generating power from moving fluids.

### BACKGROUND

There is a general desire to develop a diverse range of renewable energy technologies as the world continues to shift away from fossil fuels and toward renewables. Developing diverse solutions can help create a stronger and more resilient power grid.

Moving bodies of fluids such as wind, rivers, streams, and tidal currents offer opportunities for renewable energy production. Many countries currently have large amounts of untapped hydro and wind resources. For example, it has been estimated that the rivers in Canada can collectively generate more than 340 GW of hydrokinetic power while tidal currents in Canada can collectively generate an additional 40 GW. The total amount of power that can be generated from rivers and tidal currents alone is well over Canada's current entire electricity generating capacity.

In hydro power generation, directly capturing the hydrokinetic power of a river (e.g., through use of rotary mechanical devices like turbines) has several advantages over techniques that involve damming the flow with a hydroelectric plant. Hydroelectric dams have been the primary method of harnessing the power of rivers for decades, but can have a substantial negative impact on their surrounding environments. The reservoirs created by dams produce flooding which can destroy forests and wildlife habitats, and even displace communities. In addition, hydropower plants affect downstream flow conditions by degrading the water quality and disrupting the natural flow rate of the river.

Hydrokinetic turbines offer an alternative approach by directly capturing the kinetic energy of the water flow. Advantageously, hydrokinetic systems can be smaller in size compared to hydroelectric plants. Hydrokinetic systems can also minimize their footprint on a riverbed by mounting to existing infrastructure such as bridge pilings or floating platforms. In addition, hydrokinetic systems can be easily scaled by installing multiple turbines in an array to increase the amount of energy that can be generated.

Compared to wind turbines, hydrokinetic turbines can take advantage of the relatively higher energy density of water. In addition, rivers can offer a more constant and predictable energy supply, unlike wind which frequently changes in speed and direction. In contrast to wind, water flow is typically available throughout an entire day and/or year round. A cubic meter of water moving at 1 m/s (i.e., 3.6 km/hr) can contain up to eight times more energy than the same volume of air moving at 10 m/s (i.e., 36 km/hr, which corresponds to the rated wind speed of some existing wind turbines). The water in a moderately high velocity flow river (e.g., flow speeds of about 2 m/s) can have an energy density that is about 32 times greater than the energy density of wind in a typical wind farm on a typical day. Accordingly, a hydrokinetic turbine operating at 25% efficiency, installed in a location with moderately high flow velocity, can potentially produce about eight times more energy than an equally-sized wind turbine operating at 50% efficiency over the course of a year.

Despite the great potential of hydrokinetic systems and the like, such systems have not yet been widely adopted. Challenges that have been limiting advancements in the field relate to the difficulties associated with designing turbines that are efficient, durable, and/or cost-effective. Currently, the wind turbine market is dominated by the three-bladed horizontal-axis wind turbine (HAWT). After decades of development, these turbines are now able to reach efficiencies of ˜50% (i.e., efficiencies approaching the maximum theoretical limit of ˜59%) and have become a viable solution for wind energy capture around the world. Despite their developments, HAWT designs have difficulties thriving in hydrokinetic power applications.

Hydrokinetic turbines generally face far more demanding environments compared to wind turbines due to the higher density of water generating large forces and the flow of water generally being more turbulent than the flow of air. In conventional HAWT designs, the long turbine blades face large, reversing, cantilevered loads. To support these loads, expensive materials with high strength-to-weight ratios are required (e.g., fibreglass composites). Furthermore, unbalanced torque loads are generated as the blades experience different flow conditions and these loads must be absorbed by the central hub of the turbine. As HAWTs are designed only to accept flow directly parallel to their axis, a pivot is required to allow the hub and blades to be oriented to the flow. The result is a turbine that performs well in steady, laminar flow conditions, but is not suitable for conditions that are turbulent or involve frequent changes in flow direction.

There is a need for apparatus and systems that address the aforementioned challenges associated with producing energy from hydrokinetic resources, wind, and the like. There is a need for turbines that are designed to tolerate and even thrive in the turbulent and unsteady flow conditions found in hydro flows and wind flows. There is a need for turbines that can be manufactured with low-cost processes and/or recyclable materials. There is a need for cost-effective turbine designs that can help remote communities shift their energy demands away from fossil fuels and towards independently-controlled renewable energy sources such as hydrokinetic power, wind power, and the like.

### SUMMARY OF THE DISCLOSURE

One aspect of the invention relates to a vertical-axis turbine. The turbine extends longitudinally along an axis of rotation. The turbine comprises two blades disposed partially around the axis of rotation. The first and second blades have respective longitudinally extending proximal portions located relatively close to the axis of rotation, longitudinally extending distal portions located relatively away from the axis of rotation, and longitudinally extending body portions located between the proximal portions and the distal portions. A rotor assembly is coupled to an end of the first and second blades for connecting the turbine to a generator. The proximal portion of the first blade is adjacent to the body portion of the second blade. The proximal portion of the second blade is adjacent to the body portion of the first blade.

In some embodiments, the proximal portion of the first blade contacts the body portion of the second blade and the proximal portion of the second blade contacts the body portion of the first blade to form a closed volumetric region around the axis of rotation. In some embodiments, the first and second blades are made of a sheet of bendable material. The material may be steel, aluminum, carbon-reinforced plastics, or the like.

In some embodiments, the first and second blades are helically-shaped. In some embodiments, the shape of the first and second blades are defined by twisting a sheet of flexible material according to a frame with two or more pairs of battens. The two or more pair of battens may be arranged according to an outer diameter parameter, a core diameter parameter, a blade overlap parameter, and a batten rise parameter. The outer diameter parameter may be defined in a plane orthogonal to the axis of rotation as the distance between opposing distal end points of a first batten of the first blade and a first batten of the second blade. The core diameter parameter may be defined in the plane orthogonal to the axis of rotation as the transverse spacing between the first batten of the first blade and first batten of the second blade. The blade overlap parameter may be defined in the plane orthogonal to the axis of rotation as the distance between opposing proximal end points of the first batten of the first blade and the first batten of the second blade. The batten rise parameter may be defined as the distance between the distal end point of the batten to a projection of the distal end point onto the plane containing the outer diameter parameter, the core diameter parameter, and the blade overlap parameter.

In some embodiments, the blade overlap parameter is between 25% to 35% of the outer diameter parameter. In some embodiments, the blade overlap parameter is between 40% to 50% of the outer diameter parameter. In some embodiments, the blade overlap parameter is between 55% to 65% of the outer diameter parameter. The first and second blades may form a smooth and continuous surface around the axis of rotation. The frame and the battens may be integrally formed with first and second blades.

In some embodiments, the battens are made of a rigid material that is different from the material of the first and second blades. The rigid material may have higher stiffness compared to the material of the first and second blades. In other embodiments, the battens are coupled to a mast of the rotor assembly, with the mast extending longitudinally along the axis of rotation.

Turbines described herein may be used in a variety of different applications. For example, some embodiments may be used for generating power in response to a fluid that flows generally across the axis of rotation, creating movement in a fluid by rotating the vertical-axis turbine, creating a sail-like lift force applied to a turbine mount of the rotor assembly as the turbine is rotating in response to a fluid, or capturing energy simultaneously from a shaft of the rotor assembly and a sail-like lift force applied to a turbine mount of the rotor assembly.

Additional aspects of the present invention will be apparent in view of the description which follows.

### BRIEF DESCRIPTION OF THE DRAWINGS

Features and advantages of the embodiments of the present invention will become apparent from the following detailed description, taken with reference to the appended drawings in which:

FIG. 1A is a perspective view of an example embodiment of a turbine, shown with a direct drive alternator. FIG. 1B is a perspective view of an example embodiment of a turbine, shown with a pulley driven alternator. FIG. 1C is a perspective view of an example embodiment of a turbine, shown with a direct drive water pump. FIG. 1D shows an example embodiment of a turbine, shown coupled to a telephone pole. FIG. 1E shows a first blade of the FIG. 1A turbine. FIG. 1F shows a second blade of the FIG. 1A turbine. FIG. 1G is a perspective view of a section of the FIG. 1A turbine. FIG. 1H shows multiple sections of the FIG. 1A turbine.

FIG. 2A is a perspective view of guide lines illustrating variable parameters that may be used to characterize the geometry of the blades of the FIG. 1A turbine. FIG. 2B illustrates two pairs of battens that are arranged to collectively define the geometry of the FIG. 1A turbine. FIG. 2C is a top plan view of the FIG. 2A guide lines and variable parameters. FIG. 2D is a side elevation view of the FIG. 2A guide lines and variable parameters.

FIG. 3 is a geodesic mesh depicting the shape of a section of the FIG. 1A turbine formed by bending a sheet of material in accordance with edges defined by a pair of battens.

FIG. 4A is a side view of the battens of an example embodiment of a turbine in its deployed configuration. FIGS. 4B and C show the FIG. 4A battens in their intermediate configuration as they are being stowed or deployed. FIG. 4D shows the FIG. 4A battens in their folded configuration. FIG. 4E is a side view showing the battens of a tensegrity turbine according to an example embodiment. FIG. 4F illustrates exemplary fabric blades of the FIG. 4E turbine.

FIG. 5A is a perspective view of the battens of an example embodiment of a mast and yoke turbine in its deployed configuration. FIG. 5B is a perspective view of the FIG. 5A battens with guidelines that show the spatial relation between the battens. FIGS. 5C, 5D and 5E show the various degrees of freedom provided by the FIG. 5A mast and yoke system. FIG. 5F shows the FIG. 5A battens in their intermediate configuration as they are being stowed or deployed. FIG. 5G shows the FIG. 5A battens in their folded configuration.

FIGS. 6A-I show various example embodiments of turbine blades, each having a geometric shape varied based on the parameters shown in FIG. 2A.

FIGS. 7A-D show various example embodiments of turbine blades, each having different designs for its tip.

FIGS. 8A-C show various example embodiments of turbine blades, each having a different design for the edges.

FIG. 9 show use of the FIG. 1A turbine for energy generation on a freighter through the Flettner rotor “sail” effect.

### DETAILED DESCRIPTION

The description, which follows, and the embodiments described therein, are provided by way of illustration of examples of particular embodiments of the principles of the present invention. These examples are provided for the purposes of explanation, and not limitation, of those principles and of the invention.

Aspects of the present invention relate to turbines comprising one or more pairs of blades that are disposed at least partially around a central vertical axis of the turbine. For the purposes of facilitating the description, the term “vertical axis” (as used herein) refers to an axis that is generally transverse to the direction of fluid flow. For the purposes of facilitating the description, the term “central vertical axis” (as used herein) refers to the vertical axis corresponding to the axis of rotation of the turbine. Accordingly, the central vertical axis of the turbine may also be referred to herein as the “axis of rotation” of the turbine.

The blades of the turbine are formed by bending or twisting two or more sheets of material around the central vertical axis into a desired geometry. The sheets may be made of fabric or flexible materials like ripstop fabrics, nylon, polyvinyl chloride (PVC), urethane embedded polyester (e.g., material used on rigid hull inflatable boats), or the like. When fabric materials are used, the sheets may be supported, stretched, and suspended by rigid battens of the turbine. Alternatively, the sheets may be made of solid materials that are sufficiently bendable into the desired geometries of the blades. Such materials do not necessarily need to be compatible with 3D forming processes. Examples of suitable materials include but are not limited to: steel, aluminum, plastics, carbon-reinforced plastics, cementitious fabric materials, plywood (e.g., plywood that is pre-bent in manufacturing), and the like. When solid materials like aluminum or steel sheets are used, battens may not be required, as the joined sheets can form a monocoque, stressed skin assembly, which requires minimal internal support. In embodiments with a large number of sheets or battens, the blades can form, comprise or otherwise provide a smooth and continuous surface around the central vertical axis. In embodiments with a small number of sheets or battens, the blades will tend to form a relatively less smooth surface.

Preferred embodiments relate to vertical axis turbines (e.g., vertical-axis wind turbines (VAWTs) or vertical-axis hydro turbines (VAWTs)) that do not need to be oriented into the direction of fluid flow to facilitate power generation. Such turbines can be designed to form geometries that mitigate or even avoid some of the problems encountered by conventional turbine designs in hydrokinetic applications, or the like. In some cases, the geometry of the turbines may be designed (e.g., based on the material and/or number of sheets and battens) to achieve higher durability, reduce cost of manufacturing, and/or increase tolerance to turbulence and changes in flow direction.

Turbines described herein may be used to react to fluid and/or to impart motion to fluid. In some embodiments, the turbines are designed and used to capture shaft power (e.g., by slowing and changing direction of a moving fluid). In other embodiments, the turbines are designed to be powered and used (e.g., as a Flettner rotor) to impart motive forces on its mount.

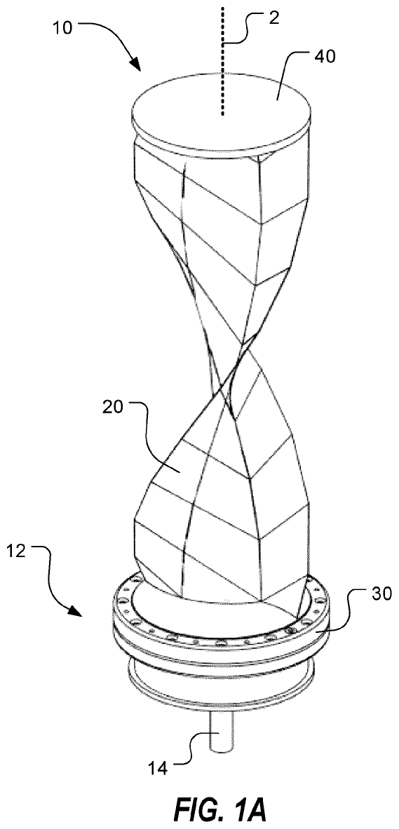

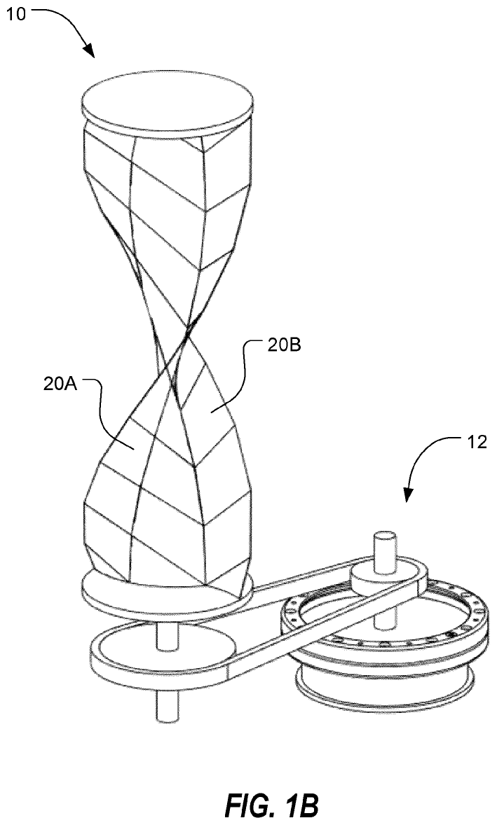

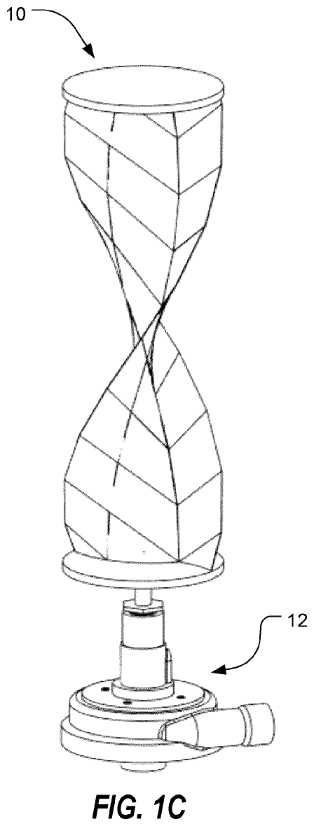

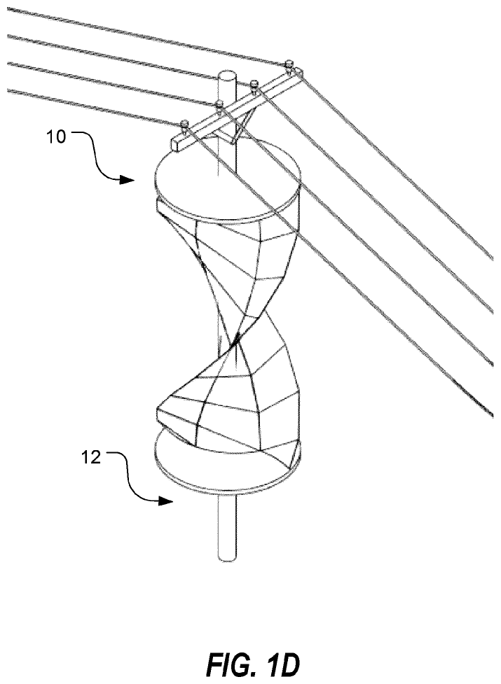

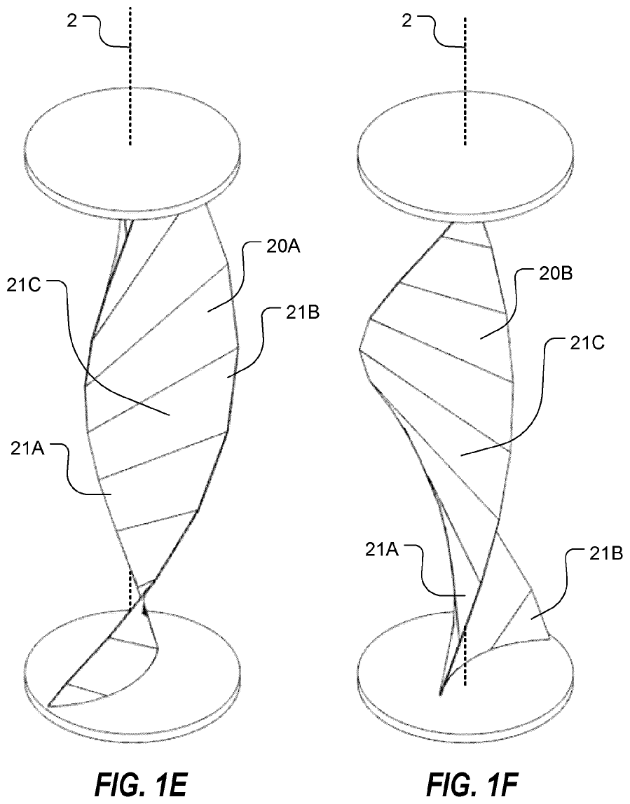

FIG. 1A is a perspective view of a turbine 10 according to an example embodiment. Turbine 10 comprises one or more pairs of blades 20 disposed at least partially around central vertical axis 2 of turbine 10. Blades 20 are formed into a desired shape as described in more detail below. Blades 20 are coupled to a rotor assembly 12. Rotor assembly 12 can be connected to a generator (not shown) to convert energy harvested from moving fluids to electric power. Rotor assembly 12 includes a rotor mast 14 and other components (e.g., gears, gearboxes, shafts, etc., bearings, etc.) for connecting to the generator.

Blades 20 may be coupled to rotor assembly 12 through a base 30 at a bottom end of blades 20 as shown in FIG. 1A. Base 30 may be disc-shaped (e.g., as shown in the example embodiment illustrated in FIG. 1A) or shaped in other manners suitable for coupling blades 20 to rotor assembly 12. Alternatively, blades 20 may be coupled directly to a mast 14 of rotor assembly 12 extending along central vertical axis 2.

In the example embodiment shown in FIG. 1A, blades 20 extend between base 30 and tip 40 in a longitudinal direction that is generally parallel to central vertical axis 2. Tip 40 is located at a top end of blades 20. Like base 30, tip 40 may be disc-shaped or shaped in other suitable manners as described in more detail below.

In other embodiments blades 20 are characterized as one or more of the following: two overlapping curved sheets or blades whose trailing edges (i.e., innermost semi-vertical edge) are coincident with the concave surface of the other blade; two or more pairs of sheets or blades that create a complex 3D curving surface which is inherently stiff when the pair(s) are joined together; a consistently and minimally distorted 3D curving surface; and/or an archimedean screw with geometry configurable to support a wide range of pitches, center diameters and overlap ratios; blades that have an hourglass shape with curving edges that join the adjacent blade in its foil; blades twisted along the axis of rotation such that their hourglass edges become straight lines that intersect adjacent blades with surfaces that are close to tangent; blades having the shape of a variation of the archimedean screw whereby the wings and the central tube of the blades are made from the same twisted sheet and the resulting screw formed thereby can be formed with no inside sharp corner at the junction of the blade and central tube, or with a minimal inside corner at this junction.

Turbine 10 may be coupled to or integrated with different types of power generators, pumps, and the like. Turbine 10 may be adapted for use under different configurations as a source of shaft power. For example, turbine 10 may be used with a direct drive alternator as shown in the FIG. 1 example embodiment. As another example, turbine 10 may be used with a pulley driven alternator as shown in FIG. 1B. As another example, turbine 10 may be used with a direct drive water pump as shown in FIG. 1C. In some embodiments, turbine 10 is designed for coupling to existing infrastructure. For example, turbine 10 may be coupled to an existing telephone pole as shown in FIG. 1C.

Turbine 10 comprises a first blade 20A and a second blade 20B. Blades 20A, 20B are illustrated in isolation in FIGS. 1E and 1F. Blades 20A, 20B are arranged together (e.g., see FIG. 1A) and disposed at least partially around central vertical axis 2. Each blade 20 comprises a proximal portion 21A located relatively close to central vertical axis 2, a distal portion 21B located relatively away from central vertical axis 2, and a body portion 21C located between proximal portion 21A and distal portion 21B. As illustrated in FIG. 1E, the proximity of each portion relative to central vertical axis 2 may be characterized in a plane orthogonal to central vertical axis 2. For turbine 10, the proximal portion 21A of the first blade 20A will lie adjacent to the body portion 21C of the second blade 20B, and the proximal portion 21A of the second blade 20B will lie adjacent to the body portion 21C of the first blade 20A.

Each blade 20A, 20B may, optionally, be in contact with each other to form a closed volumetric region 4 near central vertical axis 2 (e.g., see FIG. 1G). Each blade 20A, 20B may be shaped to form a wing portion 22A, 22B that extends toward the outer edges of turbine 10. Wing portions 22A, 22B typically correspond to distal portions 21B described above. Blades 20 may be constructed from flat strips of bendable material (e.g., steel, plastics, etc.) with cut curving edges and/or alignment holes. Such construction can help facilitate simple assembly, reduced internal bracing, and increased utilization of materials compared to traditional turbine designs. These advantages can lower manufacturing costs, and increase the range of infrastructures in which turbines 10 can be manufactured (e.g., rust belt or silicon wafer).

In some embodiments, turbine 10 is made of a low fatigue material like sheet steel. In such embodiments, the sheet steel can be coated and recoated regularly, leaving the bearings as the only component which is subject to normal wear. By using fluid film bearings, an installation of the present invention will effectively never wear out. This can be advantageous over conventional HAWT designs that require frequent blade changing (e.g., generally every 15 years) due to their cantilevering blades experiencing large reversing gravity loads.

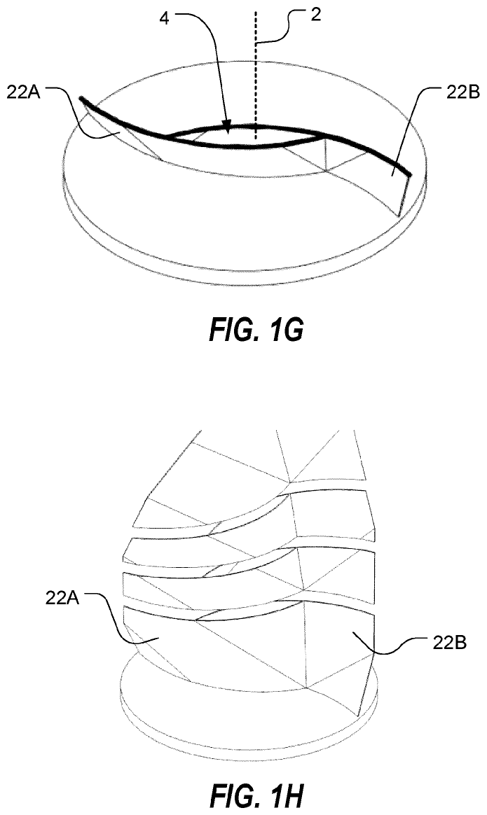

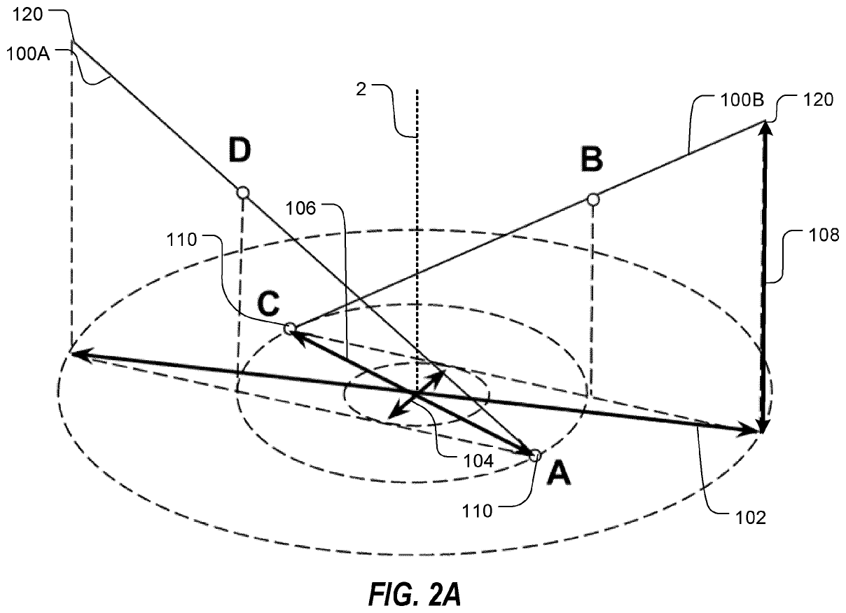

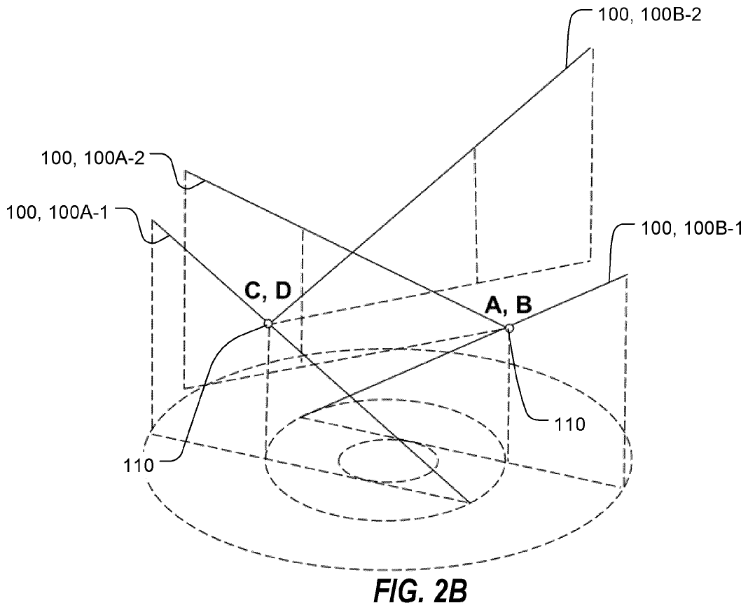

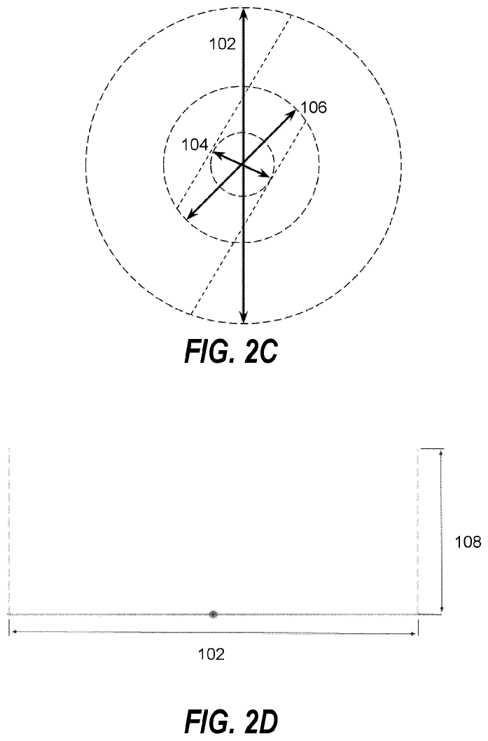

Aspects of the present invention relate to turbine designs, and turbine blade geometries in particular, that provide performance, manufacturability, durability, and other advantages over those known in the art in hydrokinetic and/or wind power generation applications. FIG. 2A is a perspective view of guide lines that help illustrate some of the variable parameters that may be used to characterize the desired geometry of blades 20. In some embodiments, the geometry and curvature of the surfaces of blades 20 are defined by four (4) variable parameters. The parameters collectively describe the shape, spacing and general geometric relation between first blade 20A and second blade 20B.

As illustrated in FIG. 2B, the variable parameters may collectively define the relative positions of pairs of lines 100 along which pairs of battens can lie. The two pairs of lines 100 illustrated in FIG. 2B outline how two or more sheets of material could be bent or otherwise deformed to achieve the desired geometry of blade 20. Each line 100 includes a proximal end point 110 located relatively close to central vertical axis 2 and a distal end point 120 located relatively far away from central vertical axis 2 (see FIG. 2A).

For the purposes of facilitating the description, the first pair of lines 100A-1, 100B-1 may be considered herein as being located on a “first layer” while the second pair of lines 100A-2, 100B-2 may be considered herein as being located on a “second layer”. As illustrated in FIG. 2B, the proximal end point 110 of the first line of the second layer 100A-2 is adjacent to the second line of the first layer 100B-1, and the proximal end point 110 of the second line of second layer 100B-2 is adjacent to the first line of the first layer 100A-1.

As described in more detail below, lines 100 define the three-dimensional (3D) geometric shape of blades 20. In some embodiments, lines 100 define the position of battens made of physical strips of solid material (e.g., plastic, metal, etc.) that help provide a structural frame for blades 20 (i.e. the battens are positioned along the lines 100). In such embodiments, battens 100 may have relatively high stiffness and/or strength compared to the other materials forming blades 20. For example, battens 100 may be made of strips of high strength steel and adapted to support therebetween plastic sheets, or the like, that have curved surfaces to provide the desired geometry for blades 20. In other embodiments, lines 100 do not correspond to components made of materials different from the rest of blades 20. In such embodiments, lines 100 may be conceptualized as portions of blades 20 that extend along the sheet of material, wherein the sheet has been bent to provide the desired geometry for blades 20 (i.e., blades 20 are constructed by bending a sheet of material, with lines 100 defined as strip-shaped portions extending along the sheet to outline the geometry of the blade in its 3D configuration).

The manner in which lines or battens 100 contact each other may be constrained by one or more variable parameters (i.e., parameters that can be varied to fine-tune the exact shape of blades 20, while maintaining a generally desired 3D geometric shape). In the example illustrated in FIG. 2A, the manner in which lines or battens 100 contact each other are constrained by four (4) variable parameters.

The first variable parameter 102 defines a length for lines or battens 100 according to the desired outer diameter of turbine 10. Accordingly, first variable parameter 102 may also be referred to herein as the “outer diameter” parameter. Outer diameter 102 is defined in a plane that is orthogonal to central vertical axis 2. Outer diameter 102 passes through central vertical axis 2. As illustrated in FIG. 2A, the distance between opposing distal end points 120 of first batten 100A and second batten 100B corresponds to outer diameter 102.

The second variable parameter 104 defines the transverse spacing between lines or battens 100 in the same layer according to the desired core diameter of turbine 10. Accordingly, second variable parameter 104 may also be referred to herein as the “core diameter” parameter. Core diameter 104 is defined in a plane that is orthogonal to central vertical axis 2. Core diameter 104 passes through central vertical axis 2.

The third variable parameter 106 defines the lateral offset between lines or battens 100 in the same layer according to the desired overlap between blades 20 of turbine 10. Accordingly, third variable parameter 106 may also be referred to herein as the “blade overlap” parameter. Blade overlap 106 is defined in a plane that is orthogonal to central vertical axis 2. Blade overlap 106 passes through central vertical axis 2. As illustrated in FIG. 2A, the distance between opposing proximal end points 110 of first batten 100A and second batten 100B corresponds to blade overlap 106.

The fourth variable parameter 108 defines the slope of the lines or battens 100 relative to the plane in which outer diameter 102, core diameter 104 and blade overlap 106 are defined. Accordingly, fourth variable parameter 108 may also be referred to herein as the “batten rise” parameter. As illustrated in FIG. 2C, batten rise 108 is orthogonal to outer diameter 102, core diameter 104 and blade overlap 106. Batten rise 108 may be defined as the distance between a distal end point 120 of batten 100 to a projection of the distal end point 120 onto the plane containing outer diameter 102, core diameter 104 and blade overlap 106.

The desired geometry for blades 20 can be described and illustrated with reference to two or more pairs of lines or battens 100. Each pair of lines 100 located on the same level are spaced and oriented relative to each other based on the same variable parameters. For example, in the example illustrated in FIG. 2B, second layer battens 100A-2, 100B-2 are spaced and oriented relative to one another based on the same variable parameters that define the relative spacing and orientation between first layer battens 100A-1, 100A-2.

To provide the desired geometry for blades 20, first batten of the second layer 100A-2 contacts second batten of the first layer 100B-1 at a first contact point (i.e. point “A, B” in FIG. 2B). The first contact point is primarily defined by blade overlap 106. As shown in FIG. 2A, the projection of the first contact point onto the plane containing blade overlap 106 corresponds to one half of the blade overlap 106. Similarly, second batten of second layer 100B-2 contacts first batten of the first layer 100A-1 at a second contact point (i.e. point “C, D” in FIG. 2B). The second contact point is primarily defined by blade overlap 106. As shown in FIG. 2A, the projection of the second contact point onto the plane containing blade overlap 106 corresponds to one half of the blade overlap 106.

The shape of blades 20 may be defined by bending a sheet and aligning opposing edges of the sheet with battens 100 from different levels. For example, in the illustrated embodiment in FIG. 2B the shape of first blade 20A can be defined by bending a sheet of material to align opposing edges of the sheet with first batten of the first layer 100A-1 and first batten of the second layer 100A-2, and the shape of second blade 20B can be defined by bending a sheet of material to align opposing edges of the sheet with second batten of the first layer 100B-1 and second batten of the second layer 100B-2.

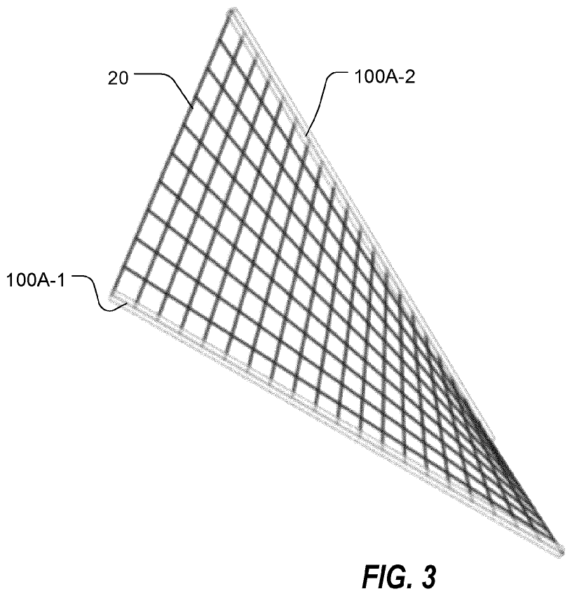

FIG. 3 is a geodesic mesh depicting the shape of a section of blade 20 defined by bending a sheet of material to align its opposing edges with a pair of battens 100A-1, 100A-2. A geodesic mesh is a series of straight lines arranged in a way to approximate the geometry of a 3D curved surface, with the accuracy of the arrangement dictated by the density of the mesh created. In some embodiments, the shape of blade 20 can be characterized as a geodesic mesh with edges or bounds defined by battens 100. The geodesic mesh provides a concise description for an approximation of a compound curving surface based on a series of connected flat surfaces with precisely defined edges. The accuracy of the approximation (i.e., smoothness of the final surface) compared to the ideal 3D curving surface is determined by the subdivision frequency or size of the mesh members relative to the entire mesh. Illustratively, an infinite number of subdivisions will correspond to a perfectly smooth surface. Accordingly, some embodiments of blade 20 may be characterized with a mesh size parameter.

With the geodesic mesh characterization of blades 20, the amount of natural flex and/or elasticity or compressibility provided by the sheet material determines how closely blade 20 can bend or otherwise form a smooth 3D curving surface. For example, materials such as fabric may be deformed easily in large sheets to create a 3D curving surface with a mesh approaching infinite density. Accordingly, blades 20 constructed from such materials may comprise a generally smooth and continuous curving surface. Construction of blades 20 with materials that have a lower K factor relative to fabrics, such as sheet metal, can be adapted according to a desired smoothness, or mesh subdivision frequency, to create blades 20 with approximately smooth 3D curving surfaces.

With parameters like the desired smoothness, outer diameter 102, inner diameter 104, blade overlap 106 and batten rise 108, the exact shape of blades 20 can be configured during manufacturing based on different types of fluids (e.g., wind, water, etc.) and/or different flow velocities, while maintaining the general shape of turbine 10 to provide performance advantages over traditional turbines. In addition, blades 20 that are shaped according to geodesic meshes can reduce the amount of material needed per unit volume.

In some embodiments, blades 20 are constructed with a combination of sheet materials having low K factor (e.g., fabric), stiff battens 100 (e.g., steel rods), and optionally high tensile cable or webbing. The combination of components may collectively provide a tensegrity structure, or a semi-tensegrity structure. The structure may be dynamic in character (e.g., folding, reefing, stowing, erecting, unfolding, deploying, etc.) with some or all of its compression members and tension members having variable lengths. The structure may telescope between a deployed configuration during operation and a flattened or folded configuration in storage or during downtime. The structure may also be deployed partially, variably, or in defined steps.

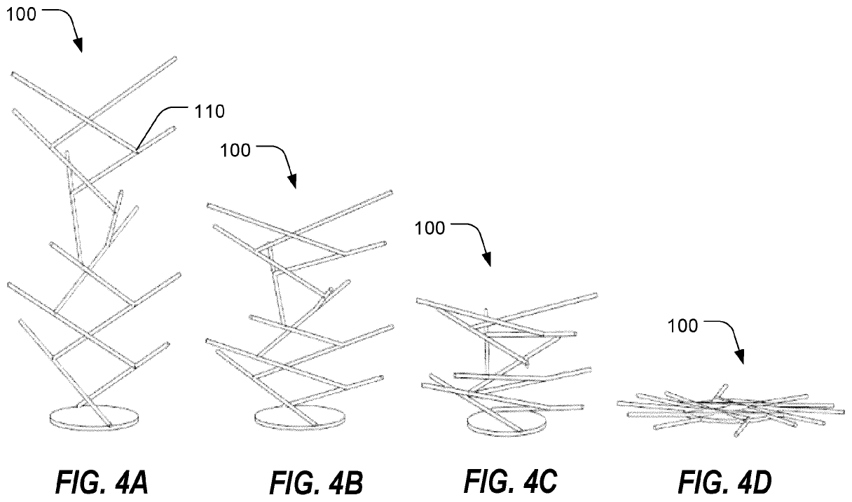

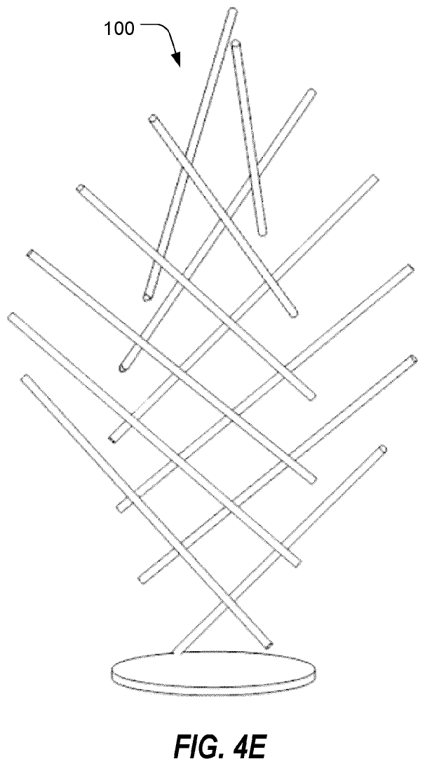

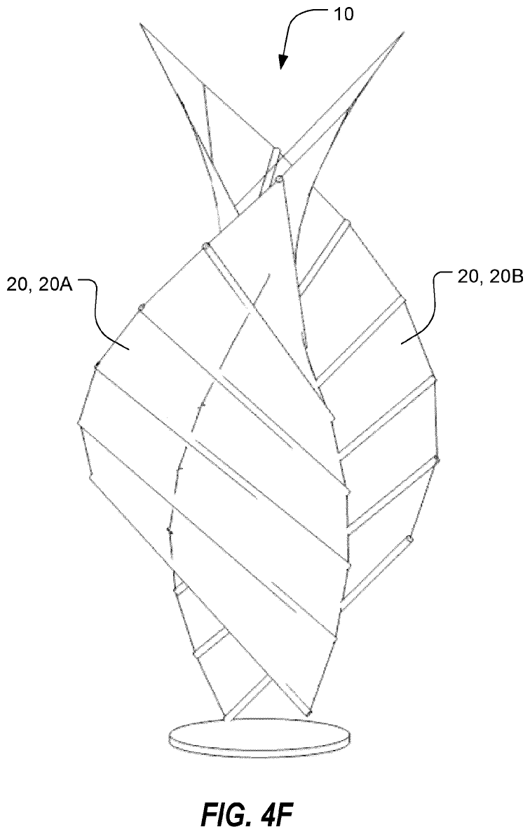

FIGS. 4A-d illustrate the semi-tensegrity structure of an example embodiment of turbine 10 shown from unfolded (FIG. 4A) through to folded configuration (FIG. 4D). In this illustrated embodiment, turbine 10 comprises six (6) layers of rigid battens 100. Each pair of battens 100 are joined by a joint (e.g., a ball type joint) to the pair above, creating a double helix structure that may act as a helical scissor lift in effect. Battens 100 are stacked on top of each other to form a frame that supports blades 20. Battens 100 in each layer are coupled to battens 100 in adjacent layers in accordance with variable parameters and configurations described above. The desired geometry of blades 20 is created by twisting a sheet of material in a helical manner to conform to the general shape outlined by battens 100. The sheet of material is fastened to batten 100.

To provide the semi-tensegrity structure, each batten 100 comprises a proximal end point 110 that is pivotally connected to another batten 100 located in the layer beneath it (or base 30 for battens 100-1 in the first layer). The pivot connections allow battens 100 and blades 20 to be telescoped down into a folded configuration when turbine 10 is not in operation (e.g., see FIGS. 4B-C). FIG. 4D is a side view illustrating battens 100 in their folded configuration.

In some embodiments, pairs of rigid battens 100 are supported in tension against one another (e.g., see FIG. 4E). In such embodiments, the rigid battens 100 may also be supported against vertically adjacent pairs of battens 100 (e.g., battens 100 located at adjacent layers) by fabric blades having a shape of the type described herein. Battens 100 along with other tension members may form a tensegrity structure (e.g., a structure where compression and tension are separated into discrete elements, and in which the compression elements are held separated in a net of tension elements) wherein the battens are compression elements, do not contact other battens, and only attach to the fabric sheet and other tension members (e.g., see FIG. 4F).

In some embodiments, the length of various tension members or compression elements may be controllably varied to allow the turbine to be modified in shape through dynamic folding and unfolding. In the example embodiment illustrated in FIG. 4E, the pairs of battens 100 are arranged such that they do not touch one another. Instead, each batten 100 is held separately in tension by the turbine skin (as shown in FIG. 4F, with additional adjustable length tension elements inside the central void providing the tension to hold the turbine rigidly erect, or allow it to fold for stowing). The turbine skin or blade 20 may nevertheless still contact one another at the same location as the non-tensegral turbine to, optionally, form closed region 4.

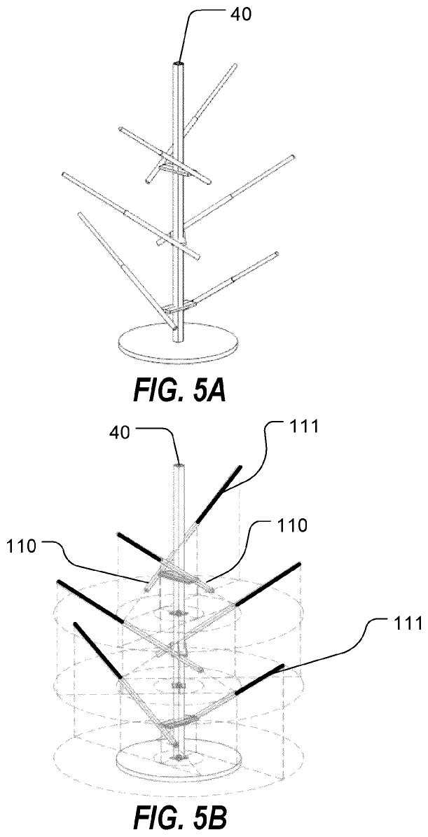

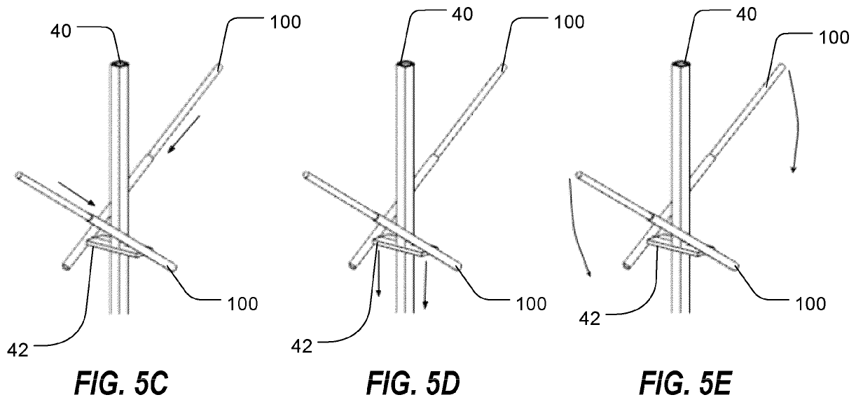

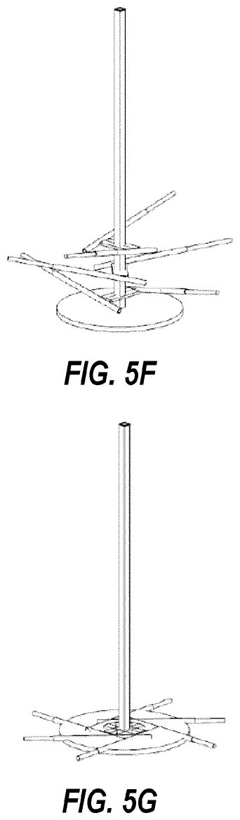

FIGS. 5A-B illustrate the structure of another example embodiment of turbine 10 with a non-rigid sail using a mast and yoke system. In this illustrated embodiment, turbine 10 comprises three (3) layers of rigid battens 100 that are supported by a mast and yoke assembly to form a frame that supports blades 20. The mast and yoke assembly may include either a rotating mast that is part of rotor assembly 12 or a non-rotating mast. The mast and yoke assembly may include a telescoping mast and/or yokes that contain a bearing system.

In the illustrated embodiment, each batten 100 is coupled to mast 40 through a yoke 42. Mast 40 may be collinear with central vertical axis 2. Each yoke 42 may be adapted to receive up to two battens 100. For example, each yoke 42 may comprise two arms that provide means for pivotally coupling batten 100 to mast 40. As illustrated in FIG. 5A, battens 100 in different layers are coupled to mast 40 at different vertical locations along mast 40 when turbine 10 is extended in its deployed position.

Battens 100 are arranged and oriented in accordance with the variable parameters and configurations described above. As shown in FIG. 5B, battens 100 have proximal end points 110 that do not directly contact the battens 100 in the layer below. However, battens 100 are positioned and oriented to align its longitudinal axis with the desired contact point of batten 100 from the layer below, wherein the desired contact point is defined by the variable parameters. This allows battens 100 to provide a frame that supports the desired shape of blades 20.

To provide the structure, each batten 100 is pivotally connected to yoke 42 (e.g., see FIG. 5E). The pivot connections allow battens 100 to pivot around an axis that is generally transverse to central vertical axis 2. Yokes 42 are slidably connected to mast 40, enabling them to move up and down mast 40 (e.g., see FIG. 5D). The pivot connections and slidable yokes 40 allow battens 100 and blades 20 to be telescoped down into a folded configuration when turbine 10 is not in operation. FIG. 5G is a perspective view of battens 100 in their folded configuration.

In some embodiments, battens 100 comprise a telescoping portion that may be extended when turbine 10 is in its deployed position and retracted when turbine 10 is in its folded position (e.g., see FIG. 5G). In such embodiments, blade 20 (e.g., a fabric sail) may be connected to the telescoping portions (e.g., the outermost portion 111 shown using thicker and darker solid lines in FIG. 5B) of battens 100. This allows turbine 10 to be stowed into a smaller structure (e.g., a structure with a smaller outer diameter) when it is not in operation. In other embodiments the telescoping outermost portion may be used in operation to throttle, or change the characteristics of turbine performance.

A wide range of variations are possible within the scope of the present invention. These variations may be applied to all of the embodiments described above, as suited, and include, without limitation, variations to the outer diameter 102, the core diameter 104, the blade overlap 106, the batten rise 108, the mesh size, the design of the tip and/or base, and the design of the edges of blades 20. The turbine may have a dynamically variable area, and may be capable of being changed in size and shape in response to the kinetic energy available, shaft energy required, and lift force produced. The area may be changed by varying height and/or diameter. In some embodiments the outermost diameter of the turbine can be varied while maintaining the general shape of the turbine. In some embodiments it may remain the same diameter while reducing in height, or it may change in both diameter and height. It may be increased in size to capture more energy or be reduced in area to the extent that it captures no energy or lift.

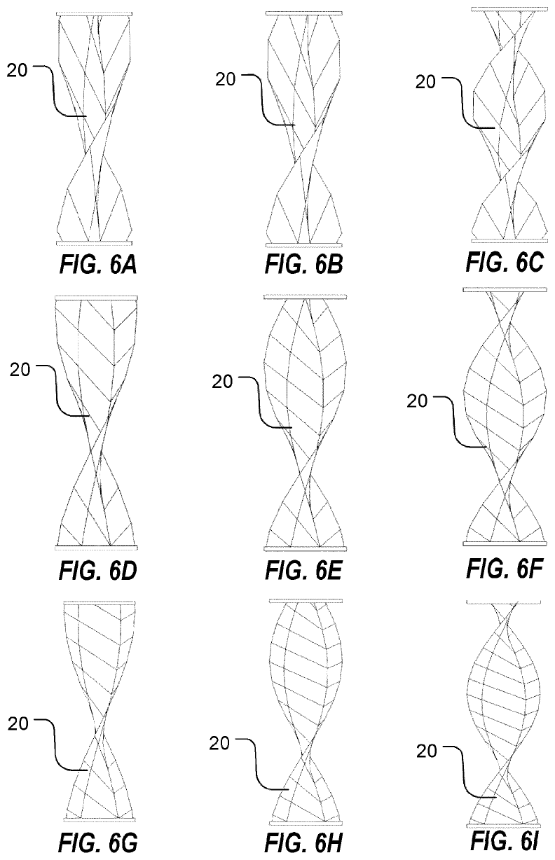

FIGS. 6A-I show nine (9) example embodiments of blades 20, each having geometric shape varied based on blade overlap 106 and a “twist” metric defining how much wing portions 22 curve as they extend in the direction of central vertical axis 2. The twist metric may be defined using units of degrees per height. Height may be normalized based on outer diameter 102 (e.g., height may be characterized in units of outer diameters) to account for the steeper rotation of the outer edge caused by a smaller outer diameter 102. The batten step height drives twist rate in a multi-panel construction. The twist metric may effectively define the slope of the outermost edge of blade 20.

FIG. 6A depicts the geometric shape of an example embodiment of blade 20 with low blade overlap (e.g., the length of blade overlap 106 is ˜30% the length of outer diameter 102) and low twist (e.g., ˜53° per diameter of height). FIG. 6B depicts the geometric shape of an example embodiment of blade 20 with low blade overlap and standard twist (e.g., ˜71° per diameter of height). FIG. 6C depicts the geometric shape of an example embodiment of blade 20 with low blade overlap and high twist (e.g., ˜89° per diameter of height). FIG. 6D depicts the geometric shape of an example embodiment of blade 20 with standard blade overlap (e.g., the length of blade overlap 106 is ˜45% the length of outer diameter 102) and low twist. FIG. 6E depicts the geometric shape of an example embodiment of blade 20 with standard blade overlap and standard twist. FIG. 6F depicts the geometric shape of an example embodiment of blade 20 with standard blade overlap and high twist. FIG. 6G depicts the geometric shape of an example embodiment of blade 20 with high blade overlap (e.g., the length of blade overlap 106 is ˜60% the length of outer diameter 102) and low twist (e.g., ˜53° per diameter of height). FIG. 6H depicts the geometric shape of an example embodiment of blade 20 with high blade overlap and standard twist. FIG. 6I depicts the geometric shape of an example embodiment of blade 20 with high blade overlap and high twist.

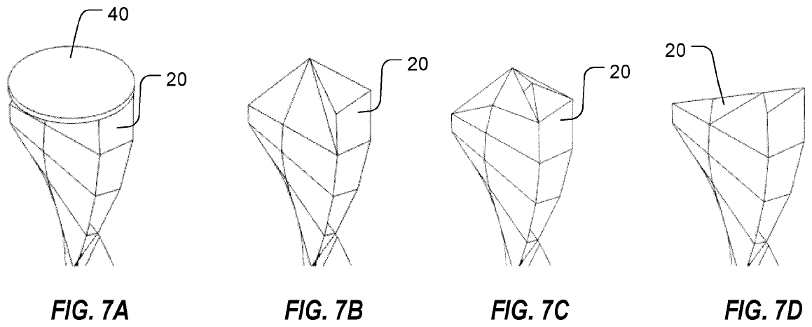

FIGS. 7A-D show four (4) example embodiments of blades 20, each having the same general geometric shape but different tip design to provide different aerodynamic characteristics. FIG. 7A shows the tip design of an example embodiment of blade 20 with an upper end plate 40. The end plate 40 may provide aerodynamic benefits for turbine 10, but can have higher structural cost compared to alternative designs. FIG. 7B shows the tip design of an example embodiment of blade 20 with a pointed tip. FIG. 7C shows the tip design of another example embodiment of blade 20 with a pointed tip. FIG. 7D shows the tip design of an example embodiment of blade 20 with a pointed bladed tip.

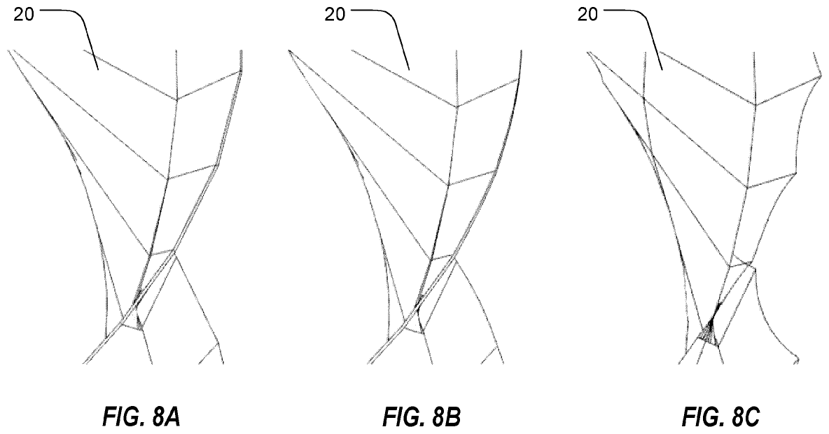

FIGS. 8A-C show three (3) example embodiments of blades 20, each having the same general geometric shape but different edge design to provide different aerodynamic, construction and aesthetic characteristics. FIG. 8A shows the edge design of an example embodiment of blade 20 formed by joining panels with straight edges. FIG. 8B shows the edge design of an example embodiment of blade 20 formed by joining panels with a concave edge to provide a smooth edge for blade 20. FIG. 8C shows the edge design of an example embodiment of blade 20 formed by joining panels with a convex edge to provide a webbed edge for blade 20. The webbed edge can function as a series of vortex generators, which may advantageously encourage high energy flows at the surfaces of blade 20. The webbed can also be easily manufactured. For example, if blade 20 is constructed from battens 100 and fabric, then its connection and termination points along the outer edge could be supported by a cable or rope, thereby naturally forming a scalloped fabric edge with reduced flutter compared to the other edge designs.

Turbine 10 may optionally include one or more of the following additional systems and/or components: generators, pumps, mounting or flotation systems, power electronics, and a flow augmentor. In some cases, the design of blades 20 can help improve the performance of the additional components and/or the overall performance of turbine 10.

For example, the performance of blades 20 can be improved with an augmentor, flow enhancing device, second turbine, or the like located downstream of blades 20 during operation. Such augmentor may comprise flow turning device(s), wing(s) and/or sail(s) oriented with the augmentors flow turning axis parallel to the turbine rotation axis.

The augmentor may be located in a direction and at a distance which provides the desired proportions of shaft power and lift from the combined effect of the turbine and augmentor. For example, the augmentor may be located within two (2) diameters from the axis of rotation 2 of turbine 10. As another example, the augmentor may be located within one diameter or less of blades 20. The augmentor may be similar in size compared to the size of blades 20. The augmentor may comprise wings that are variable in pitch. The augmentor may be designed like a wind surfer sail on a mast or designed to include telescoping or scissoring features. In some cases, the augmentor can approximately double the effective swept area of turbine 10. In some cases, the augmentor can increase the total amount of energy collected by turbine 10 by eight (8) times or more. In some cases, the augmentor or other flow-turning devices will be located downstream of turbine 10 and offset to one side of turbine 10.

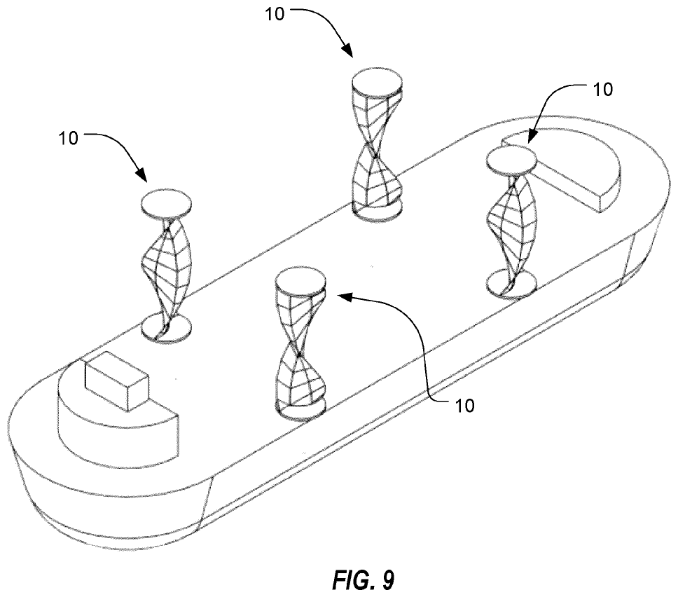

Turbines of the type described herein may be used in a variety of different ways. Exemplary use cases include, but are not limited to: generating power by rotation of the turbine in response to a fluid that flows generally across the axis of the turbine rotation, generating energy on a freighter through the Flettner rotor “sail” effect (e.g., see FIG. 9), creating movement in fluid by rotating the turbine with externally provided power, creating a sail-like lift force on a turbine mount as the turbine is rotated in response to a fluid, capturing energy via shaft power as well as the sail-like lift force simultaneously with the proportions of the lift and power being varied as desired, and displaying images or motion images by rotating turbines with visual designs printed on their surface.

The examples and corresponding diagrams used herein are for illustrative purposes only. Different configurations and terminology can be used without departing from the principles expressed herein.

Although the invention has been described with reference to certain specific embodiments, various modifications thereof will be apparent to those skilled in the art without departing from the scope of the invention. The scope of the claims should not be limited by the illustrative embodiments set forth in the examples, but should be given the broadest interpretation consistent with the description as a whole. For example, various features are described herein as being present in “some embodiments” or in “one embodiment”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express Indication that the inventors also contemplate embodiments which combine features A and B (unless the description states otherwise or features A and B are fundamentally Incompatible).

1. A vertical-axis turbine extending longitudinally along an axis of rotation, the vertical-axis turbine comprising:
first and second blades disposed partially around the axis of rotation, the first and second blades having respective longitudinally extending proximal portions located relatively close to the axis of rotation, longitudinally extending distal portions located relatively away from the axis of rotation, and longitudinally extending body portions located between the proximal portions and the distal portions; and
a rotor assembly coupled to an end of the first and second blades for connecting the vertical-axis turbine to a generator,
wherein the proximal portion of the first blade is adjacent to the body portion of the second blade, and
wherein the proximal portion of the second blade is adjacent to the body portion of the first blade.

2. The vertical-axis turbine of claim 1 wherein the proximal portion of the first blade contacts the body portion of the second blade and the proximal portion of the second blade contacts the body portion of the first blade to form a closed volumetric region around the axis of rotation.

3. The vertical-axis turbine of claim 1 wherein the first and second blades are made of a sheet of bendable material.

4. The vertical-axis turbine of claim 3 wherein the material is selected from the group consisting of: steel, aluminum and carbon-reinforced plastics.

5. The vertical-axis turbine of claim 1 wherein the first and second blades are helically-shaped.

6. The vertical-axis turbine of claim 1 wherein the shape of the first and second blades are each defined by twisting a sheet of flexible material according to a frame comprising two or more pairs of battens.

7. The vertical-axis turbine of claim 6, wherein the two or more pair of battens are arranged according to an outer diameter parameter, a core diameter parameter, a blade overlap parameter, and a batten rise parameter.

8. The vertical-axis turbine of claim 7, wherein the outer diameter parameter is defined in a plane orthogonal to the axis of rotation as the distance between opposing distal end points of a first batten of the first blade and a first batten of the second blade.

9. The vertical-axis turbine of claim 7, wherein the core diameter parameter is defined in the plane orthogonal to the axis of rotation as the transverse spacing between the first batten of the first blade and first batten of the second blade.

10. The vertical-axis turbine of claim 7, wherein the blade overlap parameter is defined in the plane orthogonal to the axis of rotation as the distance between opposing proximal end points of the first batten of the first blade and the first batten of the second blade.

11. The vertical-axis turbine of claim 7, wherein the batten rise parameter is defined as the distance between the distal end point of the batten to a projection of the distal end point onto the plane containing the outer diameter parameter, the core diameter parameter, and the blade overlap parameter.

12. The vertical-axis turbine of claim 7, wherein the blade overlap parameter is between 25% to 35% of the outer diameter parameter.

13. The vertical-axis turbine of claim 7, wherein the blade overlap parameter is between 40% to 50% of the outer diameter parameter.

14. The vertical-axis turbine of claim 7, wherein the blade overlap parameter is between 55% to 65% of the outer diameter parameter.

15. The vertical-axis turbine of claim 6, wherein the first and second blades form a smooth and continuous surface around the axis of rotation.

16. The vertical-axis turbine of claim 6, wherein the frame and the two or more pairs of battens are integrally formed with first and second blades.

17. The vertical-axis turbine of claim 6, wherein the two or more pairs of battens are made of a rigid material different from the material of the first and second blades.

18. The vertical-axis turbine of claim 17, wherein the rigid material has higher stiffness compared to the material of the first and second blades.

19. The vertical-axis turbine of claim 6, wherein the two or more pairs of battens are coupled to a mast of the rotor assembly, the mast extending longitudinally along the axis of rotation.

20. Use of the vertical-axis turbine as defined in claim 1 for generating power in response to a fluid that flows generally across the axis of rotation.

21. (canceled)

22. (canceled)

23. (canceled)

24. (canceled)
